(19) United States
(12) Patent Application Publication
(10) Pub. No.: US 2024/0054006 A1
(43) Pub. Date: Feb. 15, 2024

(54) VIRTUALIZATION PROCESSING SYSTEM, METHOD AND APPARATUS, AND DEVICE

(71) Applicant: ALIBABA GROUP HOLDING LIMITED, GEORGE TOWN (KY)

(72) Inventors: Xishi QIU, Hangzhou (CN); Naixuan GUAN, Hangzhou (CN); Yu LI, Hangzhou (CN)

(73) Assignee: ALIBABA GROUP HOLDING LIMITED, GEORGE TOWN (KY)

(21) Appl. No.: 18/547,011

(22) PCT Filed: Feb. 17, 2022
(86) PCT No.: PCT/CN2022/076558

§ 371 Date: Aug. 18, 2023

(30) Foreign Application Priority Data
Feb. 26, 2021 (CN) 202110222538.7

(51) Int. Cl. G06F 9/455; G06F 9/50

(52) U.S. Cl. CPC G06F 9/45558; G06F 9/5033; G06F 2009/45591

(57) ABSTRACT

Virtualization processing systems, methods, apparatus, and electronic devices are described herein. The systems have a virtualization infrastructure deployed on a virtual machine management and control (M&C) board side and used for constructing a virtualization system, and a management and control virtual machine deployed on a host machine side and used for managing and controlling the user virtual machine by using host machine resources. The system uses a management and control manner based on a virtual node, such that management and control are encapsulated inside a management and control virtual machine, which can be deployed on a host machine side and can also be deployed on a M&C board side. When resources of a management and control board are insufficient, one or more virtual management and control nodes can be dynamically started on the host machine side, and the node can share some management and control tasks using host machine resources.

### RELATED APPLICATION

The present application claims the priority of Chinese invention patent application No. 202110222538.7 filed on Feb. 26, 2021, and cites the disclosed content of the patent application as part of the present disclosure.

### TECHNICAL FIELD

The present application relates to the field of cloud computing technology, and in particular to a virtualization processing system, a virtualization processing method and apparatus, and an electronic device.

### BACKGROUND

Cloud computing provides diverse cloud services to customers in different fields, that is, allocating IT resources to tenants who need the IT resources as needed. When a user no longer uses resources that the user occupies, the resources are automatically released for use by other users, so that the resources may be maximized and may be expanded as needed to meet use needs timely.

Virtualization technology is one of key technologies of a cloud operating system, and may cause a hardware device to be virtualized into multiple virtual devices having independent functions, for use by multiple users at the same time. The virtualization is achieved through a virtual machine monitor (abbreviated as VMM, also known as a hypervisor or a virtualization component. The virtual machine monitor is the core of the virtualization technology. Server virtualization needs evaluation, selection, and deployment of the hypervisor. Mainstream hypervisors include virtualization technology infrastructures, such as open source Xen and KVM. With the development of the virtualization technology, the research and development of various virtualization technology infrastructures all are accompanied by overcoming of several pain point problems of the virtualization technology. The pain point problems of the virtualization include that: because virtualization components are deployed on a host machine and share resources with a user virtual machine, it is easy to cause the interference and fluctuation in the user virtual machine, such as causing the computing property loss, resource contention, TO performance bottleneck of a central processing unit (CPU). Currently, a main manner to overcome the above problems is to sink the virtual machine monitor to a virtual machine management and control board card (such as an MOC card researched and developed by Alibaba), such that host machine resources can be effectively utilized by the user virtual machine.

However, in the process of implementing the present application, the inventor discovered that after all management and control have been sunk, the above technical solution will inevitably cause a heavy burden on the virtual machine management and control board card. Not only network virtualization and storage virtualization are sunk, but also management and control related to various elastic computing services ECS s (such as quality of service QoS flow limiting management and control, log management and control, status monitoring, and the like) are also sunk. In a case where the hardware resources of the virtual machine management and control board card are fixed, there are at least the following problems: when an ECS application load surges (such as a sudden hot search scenario of a social network platform that shares short real-time information), the effect of the application load on the board card resources consumed by a management and control task is dramatically increased, and the virtual machine management and control board card cannot effectively achieve dynamic scalability of management and control resources, which therefore results in problems, such as slow virtualization speed, TO delay, network delay and the like.

### SUMMARY

The present application provides a virtualization processing system, to solve the problem existing in the prior art that the virtual machine management and control board card cannot ensure the dynamic scalability of management and control resources when the access to the ECS application load is too large, thereby affecting the virtualization speed. The present application further provides a virtualization processing method and apparatus, and an electronic device.

The present application provides a virtualization system, which includes: a virtualization infrastructure, deployed on a side of a virtual machine management and control board card and configured for constructing a virtualization system to manage a user virtual machine; and a management and control virtual machine, deployed on a side of a host machine and configured for managing and controlling use of a host machine resource by the user virtual machine.

Optionally, the system further includes: a processing apparatus for the management and control virtual machine, deployed on the side of the virtual machine management and control board card, and configured for constructing the management and control virtual machine and determining resource use situation data of the management and control board card; and, in a case where the resource use situation data of the board card does not meet a board card management and control condition, deploying the management and control virtual machine on the side of the host machine, to use a host machine resource to perform management and control.

Optionally, the processing apparatus is further configured for, in a case where the resource use situation data of the board card meets the board card management and control condition, deploying the management and control virtual machine on the side of the management and control board card, to use a board card resource to perform the management and control.

Optionally, the application level management and control includes multiple management and control tasks, and different management and control tasks correspond to different management and control virtual machines; and the processing apparatus is further configured for deploying some of the management and control virtual machines on the side of the host machine and deploying some of the management and control virtual machines on the side of the management and control board card, through a management and control virtual machine deployment strategy.

Optionally, the processing apparatus is further configured for, in a case where an application load of the user virtual machine causes the resource use situation data of the board card to not meet the board card management and control condition, switching the management and control virtual machine from deployment on the side of the management and control board card to deployment on the side of the host machine.

Optionally, the side of the host machine includes: a user virtual machine whose application load does not cause the resource use situation data of the board card to not meet the board card management and control condition.

Optionally, the board card management and control condition includes that: the resource use situation data of the board card is less than or equal to a data threshold value.

Optionally, a board card resource includes: a customized hardware resource, a processor resource, a memory resource, and a network resource; and the data threshold value includes: a customized hardware resource threshold value, a processor resource threshold value, a memory resource threshold value, and a network resource threshold value.

Optionally, the management and control virtual machine deployed on the side of the host machine communicates, in a front and back end drive vHost manner, with the user virtual machine; and the management and control virtual machine deployed on the side of the host machine communicates, in a pass-through vifo manner, with a first virtual machine monitor deployed on the side of the virtual machine management and control board card.

Optionally, the management and control virtual machine deployed on the side of the host machine communicating, in the front and back end drive vHost manner, with the user virtual machine, includes: deploying front-end drive on the side of the user virtual machine, and deploying back-end drive on the side of the management and control virtual machine.

Optionally, the host machine resource used by the management and control virtual machine deployed on the side of the host machine is isolated, in a control group manner, from the host machine resource used by the user virtual machine deployed on the side of the host machine.

Optionally, the system further includes: the virtualization infrastructure includes: an elastic computing service ECS management and control apparatus, a first virtual machine monitor, a storage client, a network client, and a customized hardware resource; the ECS management and control apparatus is configured for receiving an ECS service request and calling the first virtual machine monitor; the first virtual machine monitor is configured for performing device simulation processing, communicating with the host machine through the customized hardware resource, and communicating with a remote end through the storage client and the network client; the first virtual machine monitor communicates, through the storage client, with a storage master deployed on a cloud storage device, to facilitate performing cloud storage virtualization processing; the first virtual machine monitor communicates with another side through the network client; and the management and control virtual machine communicates with the first virtual machine monitor through the customized hardware resource.

Optionally, the system further includes: a second virtual machine monitor, deployed on the side of the host machine and configured for performing virtualization simulation of the management and control virtual machine and the user virtual machine.

Optionally, the system further includes: the managing and controlling the use of the host machine resource by the user virtual machine, includes: performing quality of service QoS flow limiting management and control on the user virtual machine; performing log management on the user virtual machine; and performing status monitoring on the user virtual machine.

Optionally, the management and control board card includes a management and control board card based on a field programmable logic gate array FPGA chip.

The present application further provides a virtualization apparatus, which includes: a management and control virtual machine construction unit, configured for constructing a management and control virtual machine, wherein the management and control virtual machine is configured for managing and controlling use of a host machine resource by a user virtual machine; a board card resource use situation determination unit, configured for determining resource use situation data of a virtual machine management and control board card; and a management and control virtual machine deployment unit, configured for, in a case where the resource use situation data of the board card does not meet a board card management and control condition, deploying the management and control virtual machine on a host machine, to use a host machine resource to perform management and control.

The present application further provides a virtualization method, which includes: constructing a management and control virtual machine, wherein the management and control virtual machine is configured for managing and controlling use of a host machine resource by a user virtual machine; determining resource use situation data of a virtual machine management and control board card; and in a case where the resource use situation data of the board card does not meet a board card management and control condition, deploying the management and control virtual machine on a host machine, to use a host machine resource to perform management and control.

Optionally, the method further includes: in a case where the resource use situation data of the board card meets the board card management and control condition, deploying the management and control virtual machine on the management and control board card, to use a management and control board card resource to perform management and control.

Optionally, the management and control virtual machine deployed on a side of the host machine communicates, in a front and back end drive vHost manner, with the user virtual machine; and the management and control virtual machine deployed on the side of the host machine communicates, in a pass-through vifo manner, with a virtual machine monitor deployed on a side of the management and control board card.

Optionally, the host machine resource used by the management and control virtual machine is isolated, in a control group manner, from the host machine resource used by the user virtual machine.

The present application further provides an electronic device, which includes: a processor and a memory; wherein the memory is configured for storing a program that implements the above method; and the device is powered on, and runs, through the processor, the program for the method.

The present application further provides a computer-readable storage medium. The computer-readable storage medium stores instructions. The instructions, when run on a computer, cause the computer to perform the above various methods.

The present application further provides a computer program product including instructions. The instructions, when run on a computer, cause the computer to perform the above various methods.

Compared with the prior art, the present application has the following advantages.

The virtualization processing system provided by the embodiment of the present application includes a virtualization infrastructure and a management and control virtual machine. Herein, the virtualization infrastructure is deployed on a side of a virtual machine management and control board card and is configured for constructing a virtualization system to manage a user virtual machine. The management and control virtual machine is deployed on a side of a host machine and is configured for managing and controlling use of a host machine resource by the user virtual machine. The system adopts a management and control manner which is based on a virtual node, and may at least achieve the following beneficial effects:

1) The management and control are encapsulated in the management and control virtual machine, which may be deployed on the side of the host machine and may also be deployed on the side of the management and control board card. In this way, when the surge of access to the user virtual machine causes the management and control board card resources insufficient, one or more virtual management and control nodes can be dynamically started on the side of the host machine, and may share a part of management and control tasks of the management and control board card and perform management and control on the virtual machine by using the host machine resource. Therefore, the dynamic scalability of the management and control resource may be continuously ensured.

2) The use of the host machine resource for management and control may improve the expandability of the management and control task.

3) The management and control performed on the side of the host machine are run in the management and control virtual machine, and management and control components are not directly run on the host machine. Therefore, this may prevent the management and control components and the user virtual machine from sharing resources, achieve isolation between the management and control components and the user virtual machine, and control the interference, of the management and control performed by the host machine, on the user virtual machine, such that the higher-grained resource isolation and higher security are achieved between the management and control virtual machine and the user virtual machine.

4) The virtual machine management and control board card only needs to meet the requirements of the basic architecture of the virtual machine, which may minimize the hardware resource configuration of the board card and effectively reduce the cost of the MOC card.

### BRIEF DESCRIPTION OF THE DRAWINGS

FIG. 1 is a schematic structural diagram of an embodiment of a virtualization processing system provided by the present application;

FIG. 2 is a schematic application scenario diagram of an embodiment of a virtualization processing system provided by the present application;

FIG. 3 is a specific schematic structural diagram of an embodiment of a virtualization processing system provided by the present application;

FIG. 4 is a schematic infrastructure diagram of deploying a management and control virtual machine on a side of a host machine of an embodiment of a virtualization processing system provided by the present application;

FIG. 5 is a schematic structural diagram of an embodiment of a virtualization processing apparatus provided by the present application; and

FIG. 6 is a schematic flow diagram of an embodiment of a virtualization processing method provided by the present application.

### DETAILED DESCRIPTION

Many specific details are set forth in the following description, to facilitate a full understanding of the present application. However, the present application can be implemented in many other manners that are different from manners described herein. Those skilled in the art may make similar extensions without violating the connotation of the present application. Therefore, the present application is not limited by specific implementations disclosed below.

In the present application, a virtualization processing system, method and apparatus, and an electronic device are provided. Various solutions will be described in detail one by one in the following embodiments.

### First Embodiment

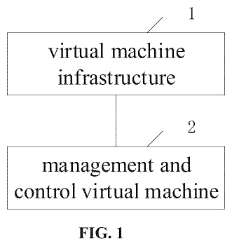

Please refer to FIG. 1, which is a schematic structural diagram of an embodiment of a virtualization processing system of the present application. In this embodiment, the system includes: a virtual machine infrastructure 1 and a management and control virtual machine 2.

The virtual machine infrastructure 1 is deployed on a side of a virtual machine management and control board card and is configured for constructing a virtualization system to manage a user virtual machine. The management and control virtual machine 2 is deployed on a side of a host machine and is configured for managing and controlling use of a host machine resource by the user virtual machine.

The host machine refers to a host of a cloud computing node (abbreviated as CN). Multiple user virtual machines may be run on the host machine, and the user virtual machine may flexibly use the host machine resource. The host machine resource may include a computing resource, a storage resource, a network resource, etc.

The virtual machine management and control board card may adopt a board card including a system on chip SOC. On the virtual machine management and control board card, an operating system OS may be installed, the user virtual machine VM may be forwarded by the network and stored. A back-end may be connected to a cloud disk (such as a Pangu cluster) and may also run various management and control tasks. In this embodiment, an intelligent SOC board card based on a PCI-E interface is used as the virtual machine management and control board card, such as a management and control board card based on a field programmable logic gate array FPGA chip, for example an MOC card. Due to the higher cost of the FPGA chip, there is a greater need for dynamic scalability of management and control resources in this situation. In addition, if the management and control board card based on the field programmable logic gate array FPGA chip is used, the hardware cost of the management and control board card may be effectively reduced after the system provided by the embodiment of the present application is applied.

The virtual machine infrastructure 1 belongs to the scope of prior art. The virtual machine infrastructure constructs a virtualization system, which may manage the user virtual machine, such as initializing the user virtual machine. The user virtual machine may be also known as a virtual host. The host machine resource includes a computing resource, a storage resource, and a network resource. After a user purchases a cloud service, the virtualization infrastructure configures a user virtual machine for the user. The user may deploy an application system (such as a social network platform that shares short real-time information) on the virtual machine of the user. In addition, the user may install a database management system (a virtual database management system) on the virtual machine, and may also deploy a content distribution network (a virtual content distribution network) on the virtual machine.

The system provided by the embodiment of the present application may be used in a bare metal scenario. A bare metal cloud is also known as a bare machine cloud, and may have both physical machine level performance and cloud elasticity. Bare metal infrastructure is to directly install a virtualization software on hardware, then install an operating system and an application on the virtualization software, and rely on a virtual layer kernel and server console for management.

In the bare metal scenario, in the prior art, all management and control tasks are sunk onto the virtual machine management and control board card. Not only the network virtualization and the storage virtualization are sunk, but also management and control tasks related to various elastic computing services ECSs are sunk. Because device resources consumed by executing the management and control tasks related to the ECSs are greatly affected by the application load, the manner of sinking all management and control tasks onto the virtual machine management and control board card will inevitably cause a heavy burden on the virtual machine management and control board card. For example, when an ECS application load surges (such as, a sudden hot search scenario of a social network platform that shares short real-time information), the virtual machine management and control board card cannot effectively achieve dynamic scalability of management and control resources.

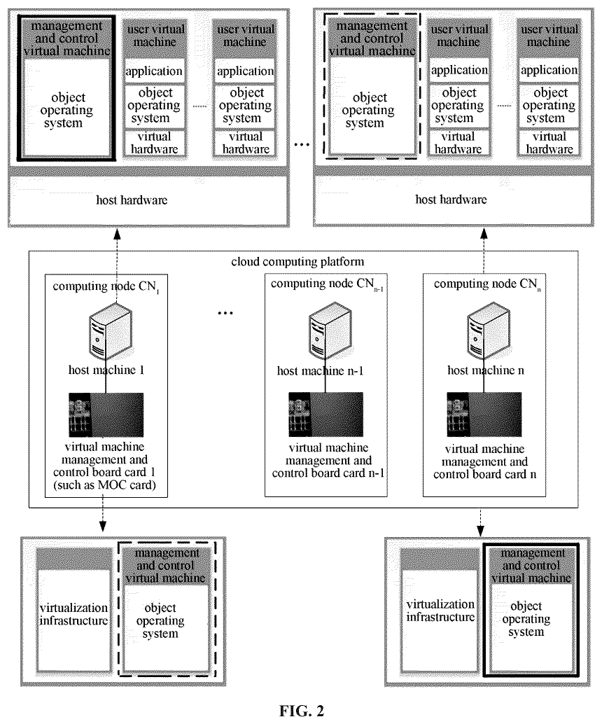

Please refer to FIG. 2, which is an application scenario diagram of an embodiment of a virtualization processing system of the present application. In this embodiment, a cloud computing platform includes multiple computing nodes (servers, abbreviated as CNs) CN1 to CNn. Each of the computing nodes includes a host machine and a virtual machine management and control board card. The virtualization infrastructure is reserved on the virtual machine management and control board card, management and control, such as related storage and network, that occupy more resources are encapsulated in a management and control virtual machine, and only a small amount of remaining management and control components are reserved on the original virtual machine management and control board card. This largely achieves decoupling from management and control of the existing virtual machine management and control board card. Multiple user virtual machines may be run on the host machine, and one or more management and control virtual machines may also be run on the host machine, to manage and control use of a host machine resource by the user virtual machine.

In addition, the management and control performed on the side of the host machine are run in the management and control virtual machine, and management and control components are not directly run on the host machine. Therefore, this may prevent the management and control components and the user virtual machine from sharing resources, achieve isolation between the management and control components and the user virtual machine, and control the interference, of the management and control performed by the host machine, on the user virtual machine, such that the higher-grained resource isolation and higher security are achieved between the virtual machine monitor and the user virtual machine. In the meanwhile, it is also convenient for the dynamic scalability of various management and control components, for example, the application of high-level properties, such as live migration, hot upgrade, hot plugging and the like.

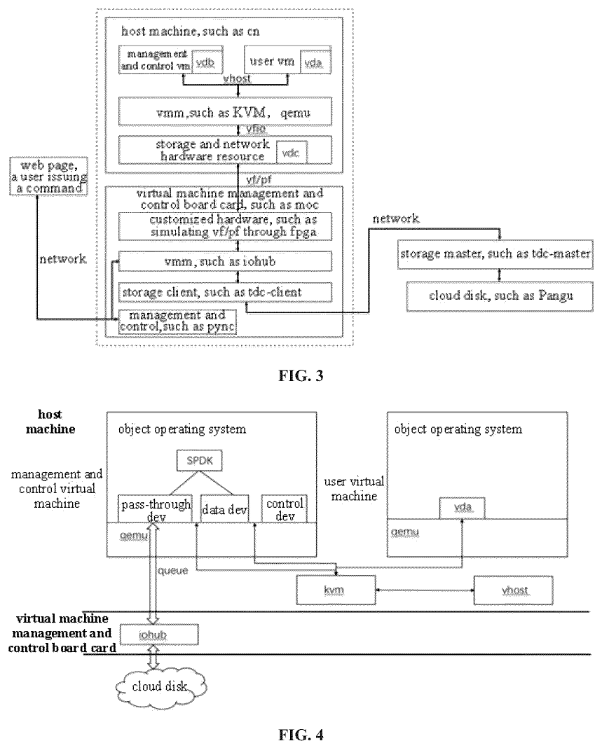

Please refer to FIG. 3, which is a specific schematic structural diagram of an embodiment of a virtualization processing system of the present application. In this embodiment, the virtualization infrastructure may include the following components related to virtualization: an elastic computing service ECS management and control apparatus, a first virtual machine monitor, a storage client, a network client, and a customized hardware resource.

Herein, the ECS management and control apparatus may be configured for receiving an ECS service request, such as receiving an ECS service command issued by a user through a web page, may initialize a user virtual machine, and may call the first virtual machine monitor, such as an input/output multi-port forwarder IO Hub, to add a remote cloud disk. The first virtual machine monitor is configured for performing device simulation processing, which may include storage virtualization and network virtualization. The first virtual machine monitor may communicate with the host machine through the customized hardware resource, and communicate with a remote end through the storage client and the network client. The first virtual machine monitor may specifically communicate with a storage master deployed on a cloud storage device (such as a cloud disk) through the storage client, to facilitate performing cloud storage virtualization processing. The first virtual machine monitor may also communicate with another side through the network client. The various components in the virtualization infrastructure described above and functions thereof belong to the prior art, and therefore will not be repeated herein.

As can be seen from FIG. 3, the system provided by the embodiment of the present application may also include a customized hardware resource on the side of the management and control board card. The management and control virtual machine deployed on the side of the host machine may communicate with the first virtual machine monitor through the customized hardware resource. In this embodiment, the customized hardware resource is a FPGA chip (an application-specific integrated circuit) configured to interact with the host machine. The management and control virtual machine interacts with an MOC, and the MOC is connected to the remote cloud disk.

In addition, a second virtual machine monitor (for example, KVM, qemu, etc.) may be also included on the side of the host machine. The second virtual machine monitor is configured for performing virtualization simulation of the management and control virtual machine and the user virtual machine, such as device simulation, CPU simulation, memory simulation and the like. The second virtual machine monitor belongs to the prior art, and therefore will not be repeated herein.

The system manages and controls, through the management and control virtual machine, use of a host machine resource by the user virtual machine, including but not limited to the management and control related to the ECS. The device resources consumed by performing the management and control related to the ECS are typically greatly affected by the ECS application load, and such management and control tasks may be increased or decreased according to application requirements.

During a specific implementation, the system managing and controlling, through the management and control virtual machine, use of a host machine resource by the user virtual machine, may include one or more of the following management and control: performing quality of service QoS flow limiting management and control on the user virtual machine; performing log management on the user virtual machine; and performing status monitoring on the user virtual machine. In addition, other management and control tasks may also be designed according to application requirements. The management and control tasks related to the ECS belong to the prior art, and therefore will not be repeated herein.

As can be seen from FIG. 3, the management and control virtual machine deployed on the side of the host machine may communicate with the user virtual machine in a front and back end drive vHost manner. The management and control virtual machine deployed on the side of the host machine may communicate with the management and control board card (such as the first virtual machine monitor) in a pass-through vifo manner by using the customized hardware resource. vHost is a back-end implementation of virtio. virtio is a para-virtualized implementation that requires both the side of the virtual machine and the side of the host machine to provide drive to complete communication. Typically, the drive on the side of the virtio host machine is implemented in the qemu of a user space, while vhost is implemented in a kernel and is a module, vhost-net.ko, of the kernel. During a specific implementation, the management and control virtual machine deployed on the side of the host machine may also communicate with the user virtual machine in a virtio manner.

In this embodiment, the management and control virtual machine deployed on the side of the host machine may communicate with the user virtual machine in the front and back end drive vHost manner, which may be implemented in the following way: deploying the front-end drive on the side of the user virtual machine, and deploying the back-end drive on the side of the management and control virtual machine. During a specific implementation, the front-end drive may be implemented by the client (the user virtual machine), and the back-end drive may be implemented by the qemu, the kernel (vhost), or the user model (vhost-user).

With respect to FIG. 3, the processing process includes the following operations: 1. a user vm accesses a vda device in a vhost manner, and the user vm has the front-end drive of the vda; 2. the back-end drive finally falls into a vdb of a management and control vm, and the vdb is given, by a vdc on a cn, to the management and control vm in a pass-through vfio manner; the io of the management and control vm uses a user model drive, such as receiving and issuing the io in a spdk manner; 3. the vdc comes from the following: iohub and tdc on a moc virtualize a Pangu cloud disk and present the virtualized Pangu cloud disk to the cn through customized hardware; 4. the vda and the vdb are of the vhost manner, the vdb and the vdc are of the vfio manner, and the vdc and the cloud disk are of the customized hardware manner; 5. the host machine and the virtual machine management and control board card are on one server.

Please refer to FIG. 4, which is a schematic infrastructure diagram of deploying a management and control virtual machine on a side of a host machine of an embodiment of a virtualization processing system of the present application. In this embodiment, the management and control virtual machine realizes, through a vHost technology, the communication with a user virtual machine and a second virtual machine monitor on the host machine. The management and control virtual machine may include: a user model drive, a device virtualization interface, a data input interface, and a control interface. The side of the management and control board card may implement a simple device simulation function (that is, implementing the first virtual machine monitor). For example, the side of the management and control board card is docked to a cloud disk (such as a Pangu cloud disk) through an input and output hub (iohub), displays a virtio device on the side of the host machine through fpga, and is connected to a remote cloud disk through a storage client. The management and control virtual machine directly connects the virtio device to the user virtual machine, that is, a pass-through dev in the figure. A hard disk vda seen by the user virtual machine is accessed to the management and control virtual machine via paths, such as kvm, vhost and the like, for management, and ultimately a drive program (such as SPDK) sends data of a user to the cloud disk.

In this embodiment, the initialization flow is described below. The first virtual machine monitor may receive an instruction, for starting the user virtual machine, sent by the host machine. The first virtual machine monitor sends the instruction to the management and control virtual machine. The management and control virtual machine constructs, through an input and output hub deployed on the management and control board card, a cloud storage docked to the user virtual machine. The first virtual machine monitor transmits a device virtualization interface corresponding to the user virtual machine to the host machine. The host machine sends the device virtualization interface to the management and control virtual machine. The management and control virtual machine docks the device virtualization interface to a user model drive. The user virtual machine is started, and gpa information to hpa information of the user virtual machine are sent to the control interface through the virtual machine monitor. The control interface establishes a mapping relationship from the gpa information to the hpa information. The management and control virtual machine accesses a memory of the user virtual machine in a shared memory manner. A vda interface is initialized through the control interface and the qemu corresponding to the user virtual machine.

In this embodiment, the flow of data input and output is described below. The user virtual machine sends input/output data to a first virtual machine monitor. The first virtual machine monitor sends the input/output data to the data input interface. The user model drive sends, through the device virtualization interface, the input/output data to the cloud storage docked to the user virtual machine.

In an example, the host machine resource used by the management and control virtual machine deployed on the side of the host machine is isolated, in a control group manner, from the host machine resource used by the user virtual machine deployed on the side of the host machine. The first virtual machine monitor isolates the host machine resource used by the management and control virtual machine from the host machine resource used by the user virtual machine. During a specific implementation, the host machine resource used by the management and control virtual machine may be isolated, in a control group (for example, cgroup) manner, from the host machine resource used by the user virtual machine. Using this processing manner may prevent the management and control virtual machine and the user virtual machine from sharing resources, and control the interference, of the management and control performed by a computing node, on the user virtual machine. Therefore, the security may be effectively improved.

In an example, the system provided by the embodiment of the present application always deploys the management and control virtual machine on the side of the host machine, and always uses the host machine resource to perform the management and control. By using this processing manner, the virtual machine management and control board card only needs to meet the resource requirements of the virtualization infrastructure, which may minimize the hardware resource configuration of the board card and effectively reduce the cost of the MOC card.

In another example, the system provided by the embodiment of the present application also deploys a processing apparatus for the management and control virtual machine on the side of the virtual machine management and control board card. The processing apparatus for the management and control virtual machine is configured for constructing the management and control virtual machine and determining resource use situation data of the management and control board card. If the resource use situation data of the board card does not meet a board card management and control condition, the management and control virtual machine is deployed on the side of the host machine, to use the host machine resource to perform the management and control. By using this manner, the management and control virtual machine can be dynamically started on the side of the host machine according to the use situation of the board card resource. The management and control virtual machine, as a virtual management and control node, may continue to perform management and control processing on the user virtual machine, which may continuously ensure the dynamic scalability of the management and control resource, for example, the application of high-level properties, such as live migration, hot upgrade, and hot plugging.

During a specific implementation, the processing apparatus may be included in the ECS management and control apparatus, and the processing apparatus may also be used as an apparatus at the same level as the ECS management and control apparatus. The system provided by the present application does not define the location of the processing apparatus.

The board card management and control condition includes but is not limited to that: the resource use situation data of the board card is less than or equal to a data threshold value. The board card resource includes: a customized hardware resource, a processor resource, a memory resource, and a network resource. Accordingly, the data threshold value includes, but is not limited to: a customized hardware resource threshold value, a processor resource threshold value, a memory resource threshold value, and a network resource threshold value.

As can be seen from FIG. 2, the management and control virtual machine may also be deployed on the side of the virtual machine management and control board card. The dotted line portion indicates that the management and control virtual machine is not deployed on this device, and the solid line portion indicates that the management and control virtual machine is deployed on this device. In this embodiment, the processing apparatus may further be configured for, if the resource use situation data of the board card meets the board card management and control condition, deploying the management and control virtual machine on the side of the management and control board card, to use a board card resource to perform the management and control. By using this manner, if the resource use situation data of the board card meets the board card management and control condition, management and control virtual machines corresponding to all application level management and control are deployed on the side of the management and control board card, which makes the management and control more pure and may effectively improve controllability of the management and control.

In an example, application level management and control includes multiple management and control tasks, and different management and control tasks correspond to different management and control virtual machines. The processing apparatus is further configured for deploying some of the management and control virtual machines on the side of the host machine and deploying some of the management and control virtual machines on the side of the management and control board card, through a management and control virtual machine deployment strategy. In this way, not only the resources of the management and control board card can be fully used for management and control, but also the dynamic scalability requirements of the management and control resources when the application load is too large can be met, thereby implementing fine-grained dynamic scalability management of the management and control resources. Therefore, this may effectively take into account effects of two aspects, i.e., the management stability and the reduction of the impact on the user virtual machine.

The management and control virtual machine deployment strategy may be determined according to application requirements. For example, according to the data of device resources consumed by different application level management and control tasks, the management and control virtual machines corresponding to the management and control tasks with less resource consumption may be deployed on the side of the virtual machine management and control board card, and the management and control virtual machines corresponding to the management and control tasks with more resource consumption may be deployed on the side of the host machine, and so on.

In an example, the processing apparatus is further configured for, if an application load of the user virtual machine causes the resource use situation data of the board card to not meet the board card management and control condition, switching the management and control virtual machine from deployment on the side of the management and control board card to deployment on the side of the host machine. For example, when the application load on the user virtual machine surges (such as a sudden hot search scenario of a microblog), the management and control virtual machine deployed on the side of the management and control board card will consume more device resources. If the management and control board card resources are insufficient, the management and control virtual machine is dynamically switched from deployment on the side of the management and control board card to deployment on the side of the host machine, which may ensure the stability of management and control.

During a specific implementation, switching the management and control virtual machine from deployment on the side of the management and control board card to deployment on the side of the host machine may be achieved in a redeployment manner, and may also be achieved in a hot deployment manner.

During a specific implementation, the processing apparatus is further configured for acquiring data of an application load; determining, according to the data of the application load, whether the application load causes the resource use situation data of the board card to not meet the board card management and control condition; if it is determined that the application load does not cause the resource use situation data of the board card to not meet the board card management and control condition, switching the management and control virtual machine from deployment on the side of the management and control board card to deployment on the side of the host machine.

In an example, the side of the host machine may include: the user virtual machine whose application load does not cause the resource use situation data of the board card to not meet the board card management and control condition, such as edge calculation or a similar scenario. In this case, the management and control virtual machines corresponding to all management and control tasks may be deployed on the side of the management and control board card.

The virtualization processing system provided by the embodiment of the present application includes a virtualization infrastructure and a management and control virtual machine. Herein, the virtualization infrastructure is deployed on a side of a virtual machine management and control board card and is configured for constructing a virtualization system to manage a user virtual machine. The management and control virtual machine is deployed on a side of a host machine and is configured for managing and controlling use of a host machine resource by the user virtual machine. The system adopts a management and control manner based on a virtual node, which may at least achieve the following beneficial effects:

1) The management and control are encapsulated in the management and control virtual machine, which may be deployed on the side of the host machine and may also be deployed on the side of the management and control board card. In this way, when the surge of access to the user virtual machine causes the management and control board card resources insufficient, one or more virtual management and control nodes can be dynamically started on the side of the host machine, and may share a part of management and control tasks of the management and control board card and perform management and control on the virtual machine by using the host machine resource. Therefore, the dynamic scalability of the management and control resource may be continuously ensured.

2) The use of the host machine resource for management and control may improve the expandability of the management and control task.

3) The management and control performed on the side of the host machine are run in the management and control virtual machine, and management and control components are not directly run on the host machine. Therefore, this may prevent the management and control components and the user virtual machine from sharing resources, achieve isolation between the management and control components and the user virtual machine, and control the interference, of the management and control performed by the host machine, on the user virtual machine, such that the higher-grained resource isolation and higher security are achieved between the management and control virtual machine and the user virtual machine.

4) The virtual machine management and control board card only needs to meet the requirements of the basic architecture of the virtual machine, which may minimize the hardware resource configuration of the board card and effectively reduce the cost of the MOC card.

### Second Embodiment

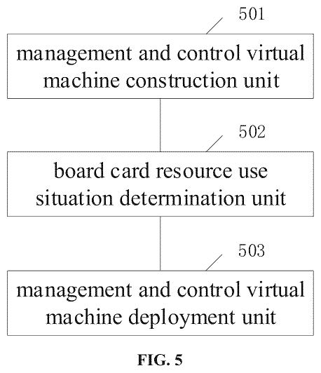

Please refer to FIG. 5, which is a schematic structural diagram of an embodiment of a virtualization processing apparatus of the present application. The virtualization processing apparatus provided by this embodiment may be deployed on a virtual machine management and control board card, and may include: a management and control virtual machine construction unit 501, a resource use situation determination unit 502, and a management and control virtual machine deployment switching unit 503.

Herein, the management and control virtual machine construction unit 501 is configured for constructing a management and control virtual machine. The management and control virtual machine is configured for managing and controlling use of a host machine resource by a user virtual machine. The resource use situation determination unit 502 is configured for determining resource use situation data of a virtual machine management and control board card. The management and control virtual machine deployment switching unit 503 is configured for, if the resource use situation data of the board card does not meet a device management and control condition, deploying the management and control virtual machine on a host machine, to use a host machine resource to perform management and control.

It can be seen from the above embodiment that, according to the virtualization processing apparatus provided by the embodiment of the present application, a management and control virtual machine is constructed, the management and control virtual machine is configured for managing and controlling use of a host machine resource by a user virtual machine; resource use situation data of a virtual machine management and control board card is determined; and if the resource use situation data of the board card does not meet a board card management and control condition, the management and control virtual machine is deployed on a host machine, to use a host machine resource to perform management and control. By using this management and control manner based on a virtual node, the management and control are encapsulated in the management and control virtual machine, which may be deployed on the side of the server and may also be deployed on the side of the management and control board card. In this way, when the surge of access to the user virtual machine causes the management and control board card resources insufficient, a virtual management and control node can be dynamically started on the side of the host machine, and may share a part of tasks of the management and control board card. Therefore, the dynamic scalability of the management and control resource may be continuously ensured. Meanwhile, the management and control performed on the side of the host machine are run in the management and control virtual machine, and management and control components are not directly run on the host machine. Therefore, this may prevent the management and control components and the user virtual machine from sharing resources, achieve isolation between the management and control components and the user virtual machine, and control the interference, of the management and control performed by the server, on the user virtual machine, such that the higher-grained resource isolation and higher security are achieved between the virtual machine monitor and the user virtual machine.

### Third Embodiment

In the above embodiment, the virtualization processing system is provided. Correspondingly, the present application also provides a virtualization processing method. The execution subject of the method includes but is not limited to a virtual machine management and control board card, and may also be any device that can implement the method. This method corresponds to the above system embodiment. The method embodiment is described briefly, since the method embodiment is substantially similar to the system embodiment, and the related contents may refer to the description of the system embodiment. The method embodiment described below is only illustrative.

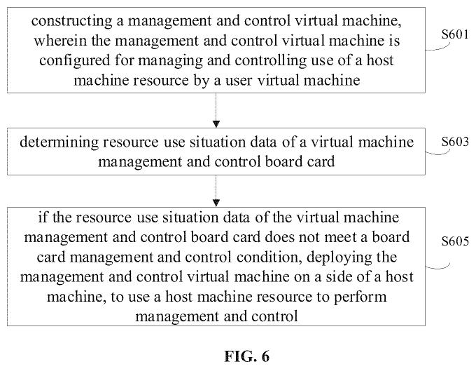

Please refer to FIG. 6, which is a schematic flow diagram of an embodiment of a virtualization processing apparatus of the present application. The present application provides a virtualization processing method including steps S601 to S605.

Step S601, constructing a management and control virtual machine, wherein the management and control virtual machine is configured for managing and controlling use of a host machine resource by a user virtual machine.

Step S603, determining resource use situation data of a virtual machine management and control board card.

Step S605, if the resource use situation data of the board card does not meet a board card management and control condition, deploying the management and control virtual machine on a host machine, to use a host machine resource to perform management and control.

The board card management and control condition includes but is not limited to that: the resource use situation data of the board card is less than or equal to a data threshold value. The board card resource includes: a customized hardware resource, a processor resource, a memory resource, and a network resource. Accordingly, the data threshold value includes, but is not limited to: a customized hardware resource threshold value, a processor resource threshold value, a memory resource threshold value, and a network resource threshold value.

During a specific implementation, the virtual machine management and control board card may initialize the management and control virtual machine through a run operating system, and start the management and control virtual machine on the side of the host machine.

In an example, the method may further include the following step: if the resource use situation data of the board card meets the board card management and control condition, deploying the management and control virtual machine on the management and control board card, to use a management and control board card resource to perform management and control.

In an example, the management and control virtual machine deployed on a side of the host machine communicates with the user virtual machine in a front and back end drive vHost manner; and the management and control virtual machine deployed on the side of the host machine communicates with a virtual machine monitor deployed on a side of the management and control board card in a pass-through vifo manner.

In this embodiment, the side of the virtual machine management and control board card may only implement a simple device simulation function, that is, iohub is docked to a Pangu cloud disk, and a virtio device is displayed on the side of the host machine. The management and control virtual machine directly connects the virtio device to a VM, that is, a pass-through dev in the figure. A vda seen by the user virtual machine is accessed to the management and control virtual machine via paths, such as kvm, vhost and the like, for management, and ultimately a driver (such as SPDK) sends data of a user to the cloud disk.

During a specific implementation, the initialization flow of the user virtual machine may adopt a processing process described below. The virtual machine management and control board card receives a command for starting the user virtual machine, and sends the command to the management and control virtual machine. The management and control virtual machine may use the iohub to construct a Pangu cloud disk corresponding to the user virtual machine, and to pass through the management and control virtual machine, so as to present the Pangu cloud disk in a pass-through dev manner (the side of the virtual machine management and control board card reports the virtio device to the host machine, and then the host machine directly connects the virtio device to the management and control virtual machine). The Pangu cloud disk is docked to a SPDK user model drive (as a back-end). The input end of the SPDK comes from the data dev, and the output end of the SPDK is the pass-through dev. The user virtual machine is started, and user_vm_gpa to hpa information of the user virtual machine are given, through a second virtual machine monitor (such as kvm), to the control dev of the management and control virtual machine. The control dev establishes mapping from the manager_vm_gpa of the management and control virtual machine to the hpa of the management and control virtual machine, such that in a shared memory manner, the management and control virtual machine can access the memory of the user virtual machine during a subsequent io operation, that is, the gpa in the management and control virtual machine may correspond to the gpa in the user virtual machine. The initialization related to the vda device (a virtio-based device) is performed through the control dev and the qemu corresponding to the user virtual machine, and then the user virtual machine is started completely.

During a specific implementation, the IO flow of the user virtual machine may adopt a processing process described below. The user virtual machine issues IO data. The front-end is a virtio-based device. After the kvm, the docked back-end is a customized vhost. However, the vhost does not perform actual processing, but simply encapsulates information and transmits the encapsulated information to the kvm, and the kvm forwards the encapsulated information to the data dev for real back-end processing. After the data dev (vring-based dev) receives the information, the data dev processes the information in a vhost-user manner, and is docked to the SPDK drive (as the front-end). The SPDK drive issues the processed information through the user model drive. Due to the pass-through device, the information will not be processed on the side of the CN, but will be directly issued to the cloud disk.

In an example, the host machine resource used by the management and control virtual machine is isolated, in a control group manner, from the host machine resource used by the user virtual machine.

It can be seen from the above embodiment that, according to the virtualization processing method provided by the embodiment of the present application, a management and control virtual machine is constructed, wherein the management and control virtual machine is configured for managing and controlling use of a host machine resource by a user virtual machine; resource use situation data of a virtual machine management and control board card is determined; and if the resource use situation data of the board card does not meet a board card management and control condition, the management and control virtual machine is deployed on a host machine, to use a host machine resource to perform management and control. By using this management and control manner based on a virtual node, the management and control are encapsulated in the management and control virtual machine, which may be deployed on the side of the server and may also be deployed on the side of the management and control board card. In this way, when the surge of access to the user virtual machine causes the management and control board card resources insufficient, a virtual management and control node can be dynamically started on the side of the host machine, and may share a part of tasks of the management and control board card. Therefore, the dynamic scalability of the management and control resource may be continuously ensured. Meanwhile, the management and control performed on the side of the host machine are run in the management and control virtual machine, and management and control components are not directly run on the host machine. Therefore, this may prevent the management and control components and the user virtual machine from sharing resources, achieve isolation between the management and control components and the user virtual machine, and control the interference, of the management and control performed by the server, on the user virtual machine, such that the higher-grained resource isolation and higher security are achieved between the virtual machine monitor and the user virtual machine.

### Fourth Embodiment

In the above embodiment, the virtualization processing method is provided. Correspondingly, the present application also provides an electronic device. This device corresponds to the above method embodiment. The device embodiment is described briefly, since the device embodiment is substantially similar to the method embodiment, and the related contents may refer to the description of the method embodiment. The device embodiment described below is only illustrative.

The electronic device of this embodiment includes a processor and a memory. The memory is configured for storing a program that implements any one of the above methods, and the device is powered on and runs, through the processor, the program for the method.

Although the present application discloses the above contents in preferred embodiments, these embodiments are not intended to limit the present application. Any skilled in the art may make possible changes and modifications without departing from the spirit and scope of the present application. Therefore, the scope of protection of the present application should be subject to the scope defined in the claims of the present application.

In a typical configuration, the computing device includes one or more processors (CPUs), an input/output interface, a network interface, and a memory.

The memory may include a non-permanent memory, a random access memory (RAM), and/or a non-volatile memory in a computer-readable medium, for example, a read-only memory (ROM) or a flash RAM. The memory is an example of the computer-readable medium.

1. The computer-readable medium includes permanent and non-permanent, removable and non-removable media, in which information storage may be implemented by any method or technology. The information may be computer-readable instructions, data structures, modules of programs, or other data. Examples of the computer storage medium include, but are not limited to, a phase change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital multi-function optical disk (DVD) or other optical storage, a magnetic cartridge tape, a magnetic tape magnetic disk storage, or other magnetic storage devices or any other non-transmission medium. The computer storage medium may be used for storing information that may be accessed by the computing device. According to the definition herein, the computer-readable medium does not include non-transitory storage computer-readable media, such as modulated data signals and carrier waves.

2. Those skilled in the art should understand that embodiments of the present application may be provided as a method, a system, or a computer program product. Therefore, the present application may take the form of complete hardware embodiments, complete software embodiments, or embodiments combining software and hardware aspects. Furthermore, the present application may take the form of a computer program product that is implemented on one or more computer available storage media (including but not limited to a magnetic disk memory, a CD-ROM, an optical memory, etc.) containing computer available program codes.

1. A virtualization processing system, comprising:
a virtualization infrastructure, deployed on a side of a virtual machine management and control board card and configured for constructing a virtualization system to manage a user virtual machine; and
a management and control virtual machine, deployed on a side of a host machine and configured for managing and controlling use of a host machine resource by the user virtual machine.

2. The system of claim 1, further comprising:
a processing apparatus for the management and control virtual machine, deployed on the side of the virtual machine management and control board card, and configured for constructing the management and control virtual machine and determining resource use situation data of the management and control board card; and, in a case where the resource use situation data of the management and control board card does not meet a board card management and control condition, deploying the management and control virtual machine on the side of the host machine, to use a host machine resource to perform management and control.

3. The system of claim 2, wherein,
the processing apparatus is further configured for, in a case where the resource use situation data of the management and control board card meets the board card management and control condition, deploying the management and control virtual machine on the side of the management and control board card, to use a board card resource to perform the management and control.

4. The system of claim 3, wherein,
the management and control comprises application level management and control, the application level management and control comprises a plurality of management and control tasks, and different management and control tasks correspond to different management and control virtual machines; and
the processing apparatus is further configured for deploying some of the management and control virtual machines on the side of the host machine and deploying some of the management and control virtual machines on the side of the management and control board card, through a management and control virtual machine deployment strategy.

5. The system of claim 3, wherein,
the processing apparatus is further configured for, in a case where an application load of the user virtual machine causes the resource use situation data of the management and control board card to not meet the board card management and control condition, switching the management and control virtual machine from deployment on the side of the management and control board card to deployment on the side of the host machine.

6. The system of claim 3, wherein,
the side of the host machine comprises: a user virtual machine whose application load does not cause the resource use situation data of the management and control board card to not meet the board card management and control condition.

7. The system of claim 2, wherein,
the board card management and control condition comprises that: the resource use situation data of the management and control board card is less than or equal to a data threshold value.

8. The system of claim 7, wherein,
a board card resource comprises: a customized hardware resource, a processor resource, a memory resource, and a network resource; and
the data threshold value comprises: a customized hardware resource threshold value, a processor resource threshold value, a memory resource threshold value, and a network resource threshold value.

9. The system of claim 1, wherein,
the management and control virtual machine deployed on the side of the host machine communicates, in a front and back end drive vHost manner, with the user virtual machine; and
the management and control virtual machine deployed on the side of the host machine communicates, in a pass-through vifo manner, with a first virtual machine monitor deployed on the side of the virtual machine management and control board card.

10. The system of claim 9, wherein,
the management and control virtual machine deployed on the side of the host machine communicating, in the front and back end drive vHost manner, with the user virtual machine, comprises:
deploying front-end drive on the side of the user virtual machine, and deploying back-end drive on the side of the management and control virtual machine.

11. The system of claim 1, wherein,
the host machine resource used by the management and control virtual machine deployed on the side of the host machine is isolated, in a control group manner, from the host machine resource used by the user virtual machine deployed on the side of the host machine.

12. The system of claim 1, wherein,
the virtualization infrastructure comprises: an elastic computing service ECS management and control apparatus, a first virtual machine monitor, a storage client, a network client, and a customized hardware resource;
the ECS management and control apparatus is configured for receiving an ECS service request and calling the first virtual machine monitor;
the first virtual machine monitor is configured for performing device simulation processing, communicating with the host machine through the customized hardware resource, and communicating with a remote end through the storage client and the network client;
the first virtual machine monitor communicates, through the storage client, with a storage master deployed on a cloud storage device, to facilitate performing cloud storage virtualization processing;
the first virtual machine monitor communicates with another side through the network client; and
the management and control virtual machine communicates with the first virtual machine monitor through the customized hardware resource.

13. The system of claim 1, further comprising:
a second virtual machine monitor, deployed on the side of the host machine and configured for performing virtualization simulation of the management and control virtual machine and the user virtual machine.

14. The system of claim 1, wherein,
the managing and controlling the use of the host machine resource by the user virtual machine, comprises:
performing quality of service QoS flow limiting management and control on the user virtual machine;
performing log management on the user virtual machine; and
performing status monitoring on the user virtual machine.

15. The system of claim 1, wherein,
the management and control board card comprises a management and control board card based on a field programmable logic gate array FPGA chip.

16. (canceled)

17. A virtualization processing method, comprising:
constructing a management and control virtual machine, wherein the management and control virtual machine is configured for managing and controlling use of a host machine resource by the user virtual machine;
determining resource use situation data of a virtual machine management and control board card; and
in a case where the resource use situation data of the virtual machine management and control board card does not meet a board card management and control condition, deploying the management and control virtual machine on a host machine, to use a host machine resource to perform management and control.

18. The method of claim 17, further comprising:
in a case where the resource use situation data of the virtual machine management and control board card meets the board card management and control condition, deploying the management and control virtual machine on the management and control board card, to use a management and control board card resource to perform management and control.

19. The method of claim 17, wherein,
the management and control virtual machine deployed on a side of the host machine communicates, in a front and back end drive vHost manner, with the user virtual machine; and
the management and control virtual machine deployed on the side of the host machine communicates, in a pass-through vifo manner, with a virtual machine monitor deployed on a side of the management and control board card.

20. The method of claim 17, wherein,
the host machine resource used by the management and control virtual machine is isolated, in a control group manner, from the host machine resource used by the user virtual machine.

21. An electronic device, comprising:
a processor and a memory;
wherein the memory is configured for storing a program that implements the method of claim 17; and the device is powered on, and runs, through the processor, the program for the method.
